(19) United States
(12) Patent Application Publication
(10) Pub. No.: US 2003/0164641 A1
(43) Pub. Date: Sep. 4, 2003

(54) Flexible hydraulic brake lines for golf cars having hydraulic brakes

(76) Inventor: Bryan D. Bigsby, Evans, GA (US)

Correspondence Address: HARNESS, DICKEY & PIERCE, P.L.C., P.O. BOX 828, BLOOMFIELD HILLS, MI, 48303, US

(21) Appl. No.: 10/087,461

(22) Filed: Mar. 1, 2002

(51) Int. Cl. B60T 17/00

(52) U.S. Cl. 303/1

(57) ABSTRACT

A golf car having a frame supported on a plurality of wheels and a braking device coupled to at least one of the plurality of wheels. A hydraulic system selectively outputs hydraulic fluid in response to a control input. A brake line is fluidly coupled between the braking device and the hydraulic system for carrying the hydraulic fluid under pressure. The brake line includes a flexible inner member and a braided outer member, which is sized to closely conformed to an outer shape of the flexible inner member. The braided outer member generally prevents radial expansion of the flexible inner member to minimize fluid leak and plastic deformation of the brake line and improves resistance to corrosion.

### FIELD OF THE INVENTION

The present invention generally relates to golf cars and, more particularly, relates to golf cars having improved brake lines that are generally resistant to corrosion and pressure loss.

### BACKGROUND OF THE INVENTION

Brake systems of varying design are common in golf cars and other small utility vehicles. An example of such is set forth in commonly-assigned U.S. Pat. No. 6,223,865 B1, the disclosure of which is incorporated by reference herein. While the above referenced patent discusses application of brakes to golf cars, brake systems for small vehicles and golf cars may yet be improved to minimize the potential for corrosion, the complexity of design, and the effects caused by tubing expansion under high hydraulic pressure.

Briefly, the typical golf car brake system includes a brake pedal and interconnected accelerator pedal. When the brake pedal is depressed a predetermined distance, the brake system operates in a normal or service mode. Depressing the brake pedal further and engaging a secondary toe-actuated lever engages a parking mode which maintains the golf car in a stationary position.

One particular brake system is an hydraulic fluid brake system having disk brakes. These disk brakes are responsive to hydraulic fluid pressure generated from a master cylinder. The brake pedal and associated linkage provides input to the master cylinder to generate a hydraulic fluid pressure within associated hydraulic brake lines to control the brake caliper assembly of the disk brakes.

Traditionally, in other vehicle applications, such as automobiles and trucks, hydraulic brake lines have generally consisted of a rigid steel tubing, which is shaped to follow the undercarriage contour of the vehicle to avoid interference with various frame and body components of the vehicle. This rigid steel tubing is then coupled to the vehicle using a plurality of metallic retaining clips. Once these rigid steel tubes approach the brake assembly, a section of flexible rubber line is used to fluidly couple the rigid steel tube to the brake assembly. This section of flexible rubber line is necessary to accommodate the motion of the wheels and brake assembly relative to the vehicle frame. That is, as road harshness is absorbed by the suspension, the wheels and brake assemblies move relative to the vehicle frame. This section of flexible rubber line typically enables this relative movement to be accommodated.

In conventional designs, the length of the flexible rubber line is kept as short as possible in order to minimize the radial expansion of the rubber line under hydraulic pressure. Such radial expansion of the rubber line when hydraulic pressure is applied may lead to “softening” of the brake pedal feel, which is disadvantage in most applications.

This expansion of the rubber line when hydraulic pressure is applied is particularly disadvantage in golf car applications. In a system where hydraulic pressure is used for long term parking function a constant high-pressure hydraulic Therefore, when a golf car is stored for many months with the parking brake engaged, this high hydraulic pressure may result in plastic deformation of a conventional hydraulic brake line assembly. Deformation of the brake line may then lead to reduced brake effectiveness, decreased system life, and/or “softening” of the brake pedal feel.

Still further, golf car applications are often faced with a number of unique problems, which are generally not found in conventional automobile applications. For example, as mentioned above, hydraulic brake systems in golf cars often are stored under pressure for several months, which may lead to plastic deformation of the brake lines and the associated reduction in useful life and brake effectiveness.

Furthermore, many golf cars operate in severe corrosive environments. For instance, many golf cars are exposed almost daily to caustic elements, such as fertilizers, salt, and detergents. All of these contribute to the corrosion of metallic components on the golf cars, such as metal brake lines and fasteners.

Moreover, most golf cars are powered by electric motors. The acid from the batteries, in both liquid and vapor form, tend to accelerate the corrosion of metals positioned nearby. As can be appreciated, these caustic elements and battery acid may lead to failures in conventional rigid metal brake lines and the associated fasteners.

Still further, it is often desirable in golf car applications to route brake lines away from hazardous areas, such as near the battery, and through areas of the chassis where the brake lines will be protected from snagging on brush, dirt mounds, and other hazards that the vehicle may pass over. Conventional rigid metal lines limit the routing options, since their inflexibility prohibits them from being threaded through and around chassis and frame features.

Accordingly, there exists a need in the relevant art to provide a brake line assembly for golf cars that is capable of accommodating the motion of the wheels and brake assemblies thereof without sacrificing resistance to high hydraulic pressure for prolonged periods. Furthermore, there exists a need in the relevant art to provide a brake line assembly having high pressure hydraulic brake lines that are capable of being conveniently routed around golf car components without the need for complicated pre-forming of the brake line. Still further, there exists a need in the relevant art to provide a brake line assembly that generally resists the effects of harsh environmental elements, such as caustic elements and battery acid. Lastly, there exists a need in the relevant art to provide a flexible hydraulic brake line that is capable of overcoming the disadvantages of the prior art.

### SUMMARY OF THE INVENTION

According to the teaching of the present invention, a brake line for a golf car is provided having advantageous construction. The golf car includes a frame supported on a plurality of wheels and a braking device coupled to at least one of the plurality of wheels. A hydraulic system selectively outputs hydraulic fluid in response to a control input. A brake line is fluidly coupled between the braking device and the hydraulic system for carrying the hydraulic fluid under pressure. The brake line includes a flexible inner member and a braided outer member, which is sized to closely conformed to an outer shape of the flexible inner member. The braided outer member generally prevents radial expansion of the flexible inner member to minimize fluid leak and plastic deformation of the brake line and improves resistance to corrosion. The braided outer member further prevents or at least minimizes damage caused by chaffing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an elevational, partial cut-away view of a golf car including a brake system according to the principles of the present invention;

FIG. 2 is a block diagram of the brake system;

FIG. 3 is a partial cut-away view of the brake lines; and

FIG. 4 is a perspective view of the golf car support frame and components of the brake system.

### DETAILED DESCRIPTION OF THE PREFERRED EMBODIMENTS

The following description of the preferred embodiment is merely exemplary in nature and is in no way intended to limit the invention, its application, or uses.

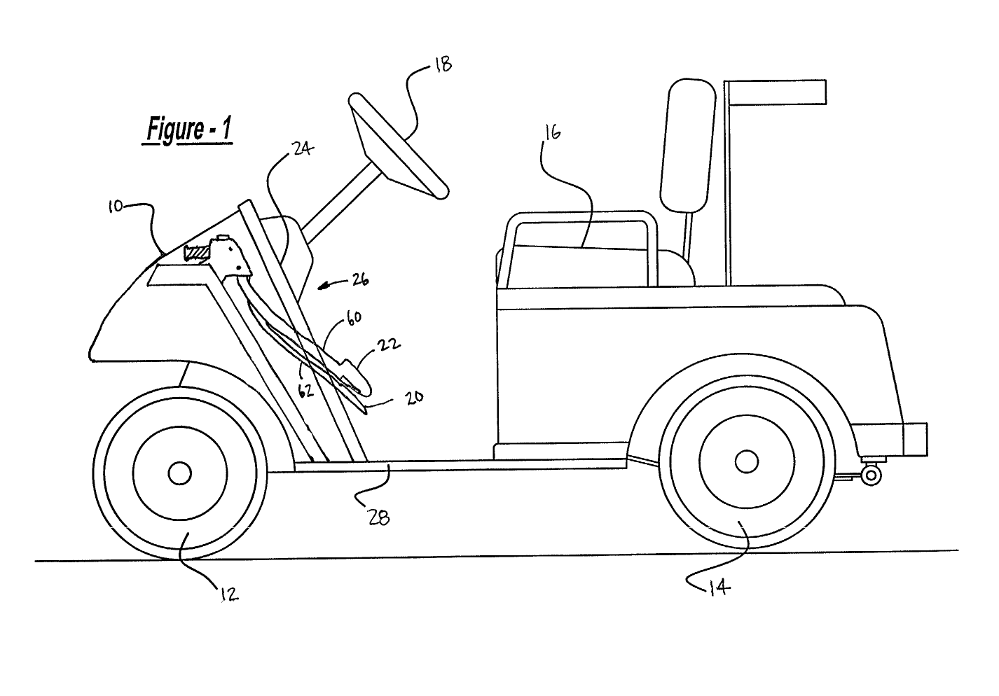

Referring now to the drawings, FIG. 1 illustrates a golf car 10 having a brake system arranged in accordance with the principles of the present invention. Golf car 10 includes a pair of front wheels 12 and a pair of rear wheels 14. Front wheels 12 preferably operate as steering wheels to control the direction of travel of golf car 10. Rear wheels 14 preferably function as drive wheels for propelling golf car 10.

Golf car 10 includes a seat 16 which accommodates a driver and a passenger. Golf car 10 also includes a steering wheel 18 which controls the direction of front wheels 12. An accelerator pedal 20 and a brake pedal 22 enable the operator to control acceleration and braking of golf car 10. Accelerator pedal 20 and brake pedal 22 preferably are suspended from support members which hang generally downwardly from underneath a front cowling 24.

Still referring to FIG. 1, an entire brake actuator and release assembly 26 is configured as a modular unit mounted above the floorboard 28 and at least partially beneath the front cowling 24. It therefore lacks any underhanging components that extend beneath the floorboard 28.

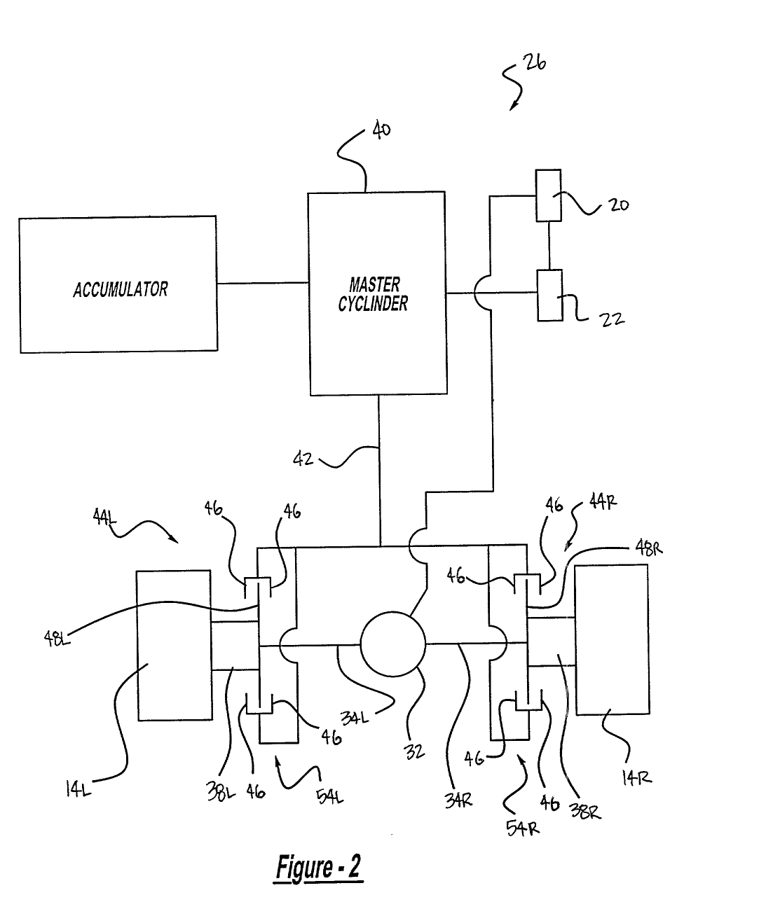

FIGS. 2 illustrates a brake system 26 according to the principles of the present invention. Accelerator pedal 20 controls operation of an electric motor 32 which is powered by a source of electrical energy (not shown). Electric motor 32 includes one or a pair of output shafts 34 which drive respective hubs 36. It should be noted that reference numerals in the drawings may include an R or L suffix to designate a component as corresponding to the left or driver's side or the right or passenger's side of golf car 10. Respective hubs 36 drive rear wheels 14 to propel golf car 10. While motor 32 is described herein as an electric motor, one skilled in the art will recognize that rear wheels 14 may be propelled by a gasoline powered engine and transmission or other suitable power source.

Brake system 26 will generally be described herein as a hydraulically actuated brake system wherein displacement of brake pedal 22 generates a hydraulic force to operate a braking element, such as a disk, drum, or band brake system. Brake system 26 includes brake pedal 22 that connects to and displaces a linkage 38. Linkage 38 provides an input to a master cylinder 40. Master cylinder 40 operates generally as a conventional master cylinder in which depressing brake pedal 22 provides an input to master cylinder 40 which generates an increase in hydraulic fluid pressure output on a hydraulic brake line 42.

Hydraulic brake line 42 provides fluid pressure to caliper assemblies 44. Each caliper assembly 44 includes opposing pads 46. A brake rotor 48 moves rotationally in accordance with hubs 36. Pads 46 apply a frictional force to brake rotor 48 to retard movement of brake rotor 48, thereby applying a braking force upon wheels 14. Caliper assemblies 44 thus operate generally as is known to one skilled in the art. In order to maximize braking force, an optional second pair of caliper assemblies 54 may be arranged to provide additional retarding force upon brake rotor 48. A particularly attractive feature of utilizing two caliper assemblies on a single brake disk is to compensate for space limitations inherent with the generally small diameter of wheels 14 of a typical golf car 10.

As described above, depressing brake pedal 22 causes master cylinder 40 to generate a hydraulic fluid output pressure in hydraulic brake line 42 which is applied to caliper assemblies 44 and to calipers assemblies 54, if present. An increase in hydraulic fluid pressure causes brake pads 46 to move toward brake rotor 48 to generate a frictional force which retards movement of wheels 14.

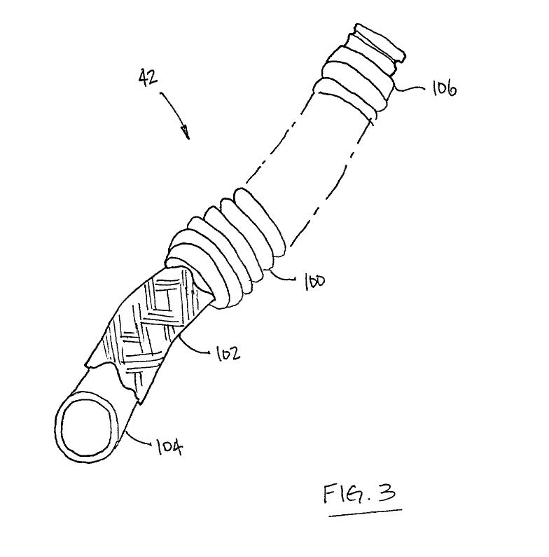

As best seen in FIG. 3, hydraulic brake line 42 is a multilayer hydraulic line that is capable of being conveniently routed through golf car 10, resists corrosion, and minimizes radial expansion during storage at high pressure. Hydraulic brake line 42 may include an optional loom cover 100, a braided stainless steel layer 102, and a flexible tubing member 104. More preferably, flexible tubing member 104 is made of polytetraflouroethylene (PTFE), such that it readily resists corrosion and the like. It should be understood that braided stainless steel layer 102 may be constructed of any material that is capable of achieving sufficient restraining properties. By way of non-limiting example, it has been found that braided layer 102 may be made of braided kevlar, nylon webbing, or the like.

Flexible tubing member 104 is disposed within braided stainless steel layer 102 in a co-axial relationship. Braided stainless steel layer 102 serves to protect flexible tubing member 104 and further to restrict radial expansion thereof. That is, under high hydraulic pressure, braided stainless steel layer 102 resists the natural tendency of flexible tubing member 104 to expand radially, which may lead to plastic deformation. Flexible tubing member 104 and braided stainless steel layer 102 may then be disposed within loom cover 100. The use of loom cover 100 eliminates the need for grommets or other protection to resist chafing of the lines against other parts of golf car 10. Furthermore, loom cover 100 further provides an additional corrosion resistant layer. Lastly, end fittings 106 are further coupled to opposing ends of hydraulic brake line 42. Preferably, end fittings 106 are plated steel and are permanently attached to flexible tubing member 104 and/or braided stainless steel layer 102.

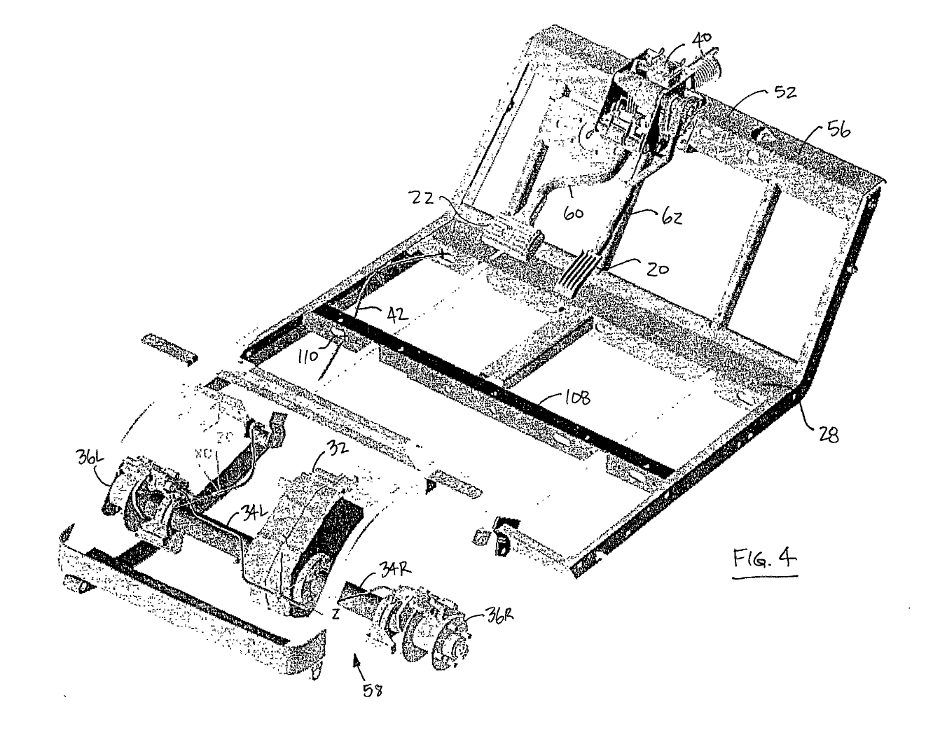

With particular reference to FIG. 4, golf car 10 includes a vehicle frame 56. Frame 56 provides a support to which brake and accelerator pedal assembly 26 connects. Rear axle assembly 58 supports a rear portion of frame 56 via a suspension (not shown). As shown in FIG. 3, brake and accelerator pedal assembly 26 mounts to an upper portion 52 of frame 56 so that brake pedal 22 is suspended downwardly on lever arm 60 and accelerator pedal 20 is suspended downwardly upon accelerator arm 62.

As best seen in FIG. 4, frame 56 further includes a plurality of cross members 108 having a plurality of routing slots 110 disposed therethrough. The plurality of routing slots 110 are particularly useful in permitting the routing of hydraulic brake line 42 around and through the plurality of cross members 108. With hydraulic brake lines 42 being routed through the plurality of slots 110, hydraulic brake lines 42 may be positioned within the structure of frame 56 so as to minimize the chance of snagging on brush, dirt mounds, and other hazards that golf car 10 may pass over. Once hydraulic brake lines 42 are routed through the plurality of slots 110, hydraulic brake lines 42 may then be fastened to frame 56 using a plurality of fasteners, preferably non-metallic fasteners such as plastic tie-wraps and the like.

According to the principles of the present invention, hydraulic brake lines 42 provide a number of distinct advantages over conventional brake line assemblies. For instance, hydraulic brake lines 42 eliminate the need for a connecting member being disposed between a rigid steel tubes and a flexible rubber line, thereby reducing material costs and assembly time. Furthermore, a standard length of hydraulic brake lines 42 may be used for a number of different golf car models, which will provide economies of scale in manufacturing. Still further, due to the inherent flexibility of hydraulic brake lines 42, these lines may be conveniently rolled for shipping, thereby resulting in smaller and lower cost packaging. Conventional rigid steel lines typically require boxes over five feet in length and are subject to shipping damage. Still further, the elimination of rigid steel lines greatly reduces the difficulty in routing and assembly the brake system of golf cars. Additionally, due to the flexibility of hydraulic brake line 42, it is no longer necessary to splice a flexible rubber line to the end of the brake line.

The description of the invention is merely exemplary in nature and, thus, variations that do not depart from the gist of the invention are intended to be within the scope of the invention. Such variations are not to be regarded as departure from the spirit and scope of the invention.

What is claimed is:

1. A golf car comprising:
a frame supported on a plurality of wheels;
a braking device coupled to at least one of said plurality of wheels;
a hydraulic system selectively outputting hydraulic fluid in response to a control input; and
a brake line fluidly coupled between said braking device and said hydraulic system, said brake line having a flexible inner member and a braided outer member, said braided outer member being sized to closely conformed to an outer shape of said flexible inner member to generally prevent radial expansion of said flexible inner member.

2. The golf car according to claim 1 wherein said flexible inner member is a PTFE tubular member.

3. The golf car according to claim 1 wherein said braided outer member is a braided stainless steel member.

4. The golf car according to claim 1 wherein said braided outer member is a braided kevlar member.

5. The golf car according to claim 1 wherein said braided outer member is a braided nylon member.

6. The golf car according to claim 1, further comprising:
a flexible cover member disposed about said flexible inner member and said braided outer member.

7. A golf car comprising:
a frame supported on a plurality of wheels;
a hydraulically operated braking device coupled to at least one of said plurality of wheels;
a hydraulic system receiving input from a brake pedal and outputting pressurized hydraulic fluid; and
a brake line operably coupled between said braking device and said hydraulical system to define a hydraulic fluid path therebetween, said brake line having a flexible tube member and a woven outer casing, said woven outer casing closely conforming in shape to an outer shape of said flexible tube member thereby minimizing radial expansion of said flexible tube member when said hydraulic system outputs said pressurized hydraulic fluid.

8. The golf car according to claim 7 wherein said flexible tube member is a PTFE tubular member.

9. The golf car according to claim 7 wherein said woven outer casing is a braided stainless steel member.

10. The golf car according to claim 7 wherein said woven outer casing is a braided kevlar member.

11. The golf car according to claim 7 wherein said woven outer casing is a braided nylon member.

12. The golf car according to claim 7, further comprising:
a flexible cover member disposed about said flexible tube member and said woven outer casing.

13. A golf car comprising:
a frame supported on a plurality of wheels;
a hydraulically operated braking device coupled to at least one of said plurality of wheels;
a hydraulic system receiving input from a brake pedal and outputting pressurized hydraulic fluid;
a brake line operably coupled between said braking device and said hydraulical system to define a hydraulic fluid path therebetween, said brake line having a flexible tube member and a woven outer casing, said woven outer casing closely conforming in shape to an outer shape of said flexible tube member thereby minimizing radial expansion of said flexible tube member when said hydraulic system outputs said pressurized hydraulic fluid; and
a flexible cover member disposed about said flexible tube member and said woven outer casing.

14. The golf car according to claim 13 wherein said flexible tube member is a PTFE tubular member.

15. The golf car according to claim 13 wherein said woven outer casing is a braided stainless steel member.

16. The golf car according to claim 13 wherein said woven outer casing is a braided kevlar member.

17. The golf car according to claim 13 wherein said woven outer casing is a braided nylon member.
